(19) United States
(12) Patent Application Publication
(10) Pub. No.: US 2024/0192696 A1
(43) Pub. Date: Jun. 13, 2024

(54) CONTROL SYSTEM WITH STATE CHANGE DETECTION AND MULTIMODAL INTERPRETATION

(71) Applicant: DASSAULT AVIATION, PARIS (FR)

(72) Inventors: Lauren DARGENT, SAINT CLOUD (FR); Hervé GIROD, SAINT-CLOUD (FR); Valentin RICHARD, SAINT-CLOUD (FR)

(21) Appl. No.: 18/534,139

(22) Filed: Dec. 8, 2023

(30) Foreign Application Priority Data
Dec. 9, 2022 (FR) FR 22 13061

(51) Int. Cl. G05D 1/222

(52) U.S. Cl. CPC G05D 1/222

(57) ABSTRACT

A control system includes a modal state change detection module configured to receive distinct modal inputs. The detection module is configured to detect a discrete state change of each modal input and to determine data characteristics of the current discrete state. The detection module also is configured to detect a user request. The control system also includes a multimodal interpretation module configured, on each detected state change, to store and update the data characteristics of the current discrete state of the modal input following the detected state change. The multimodal interpretation module is configured, on each detected incomplete request, to complete the incomplete request from the stored up-to-date characteristic data of the current discrete state of another modal input.

The present disclosure relates to a control system based on multimodal interactions of a user.

### BACKGROUND

The user, an aircraft pilot for example, can interact with a system by different means of communication involving different modalities, each modality being related to a human sense with which the user can communicate, such as speech, sight, touch, or movement.

When the user sends a request by means of a first modality, such as a voice recognition device, it is known to manage certain modalities through a time window of events. This time window allows a time correlation between the inputs/events of the different modalities, particularly in the case of modalities that provide continuous states, for example, the displacement of a cursor or a direction of gaze.

### SUMMARY

However, these known mechanisms for managing modalities are not satisfactory, particularly as they require a very complex definition of the time window for the modalities.

Furthermore, some known mechanisms only manage a limited number of modalities, typically only speech and touch, and are not adaptable to other modalities.

One aim of the present disclosure is therefore to provide a control system allowing at least two modal inputs to be generated from the same modality, or from respectively at least two distinct generic modalities, and allowing requests from a user to be handled easily.

An additional aim of the present disclosure is to provide a multimodal architecture that can manage as many different modalities as required as input, in a generic way.

To this end, the present disclosure relates to a control system comprising:
a modal state change detection module configured to receive at least two distinct modal inputs, each modal input being generated from the same modality or from respectively at least two distinct modalities;
the detection module being configured, for each modal input received, to detect a discrete state change of the modal input from a previously assigned discrete state toward a newly assigned current discrete state of the modal input, and to determine data characteristics of the current discrete state of the modal input following the detected state change;
the detection module further being configured to detect a user request from at least one of the received modal inputs;
a multimodal interpretation module configured, on each detected state change of one of the modal inputs, to store and update data characteristics of the current discrete state of the modal input following the detected state change;
the multimodal interpretation module further being configured, for each detected user request, to determine whether said request is sufficiently complete to be carried out, and, in the event of an incomplete request, to complete the incomplete request from at least one of the stored up-to-date data characteristics of the current discrete state of another modal input distinct from each modal input from which the request was detected.

The system according to the present disclosure may comprise one or more of the following features, taken singly or in any technically possible combination:
at least two of the distinct modal inputs are generated respectively by distinct modalities, the multimodal interpretation module being configured, in the event of an incomplete request, to complete the intentional incomplete request from at least one of the stored up-to-date data characteristics of the current discrete state of the modal input generated by another modality, the other modality being distinct from each modality having generated the modal input from which the intentional request was detected;
each discrete state change is detected as a function of at least one detection criterion; and, preferably, the newly assigned current discrete state is chosen from a list of at least two possible discrete states; each detection criterion and each possible discrete state advantageously being stored on a file that can be configured externally by an operator;
the multimodal interpretation module is configured, in the event of an incomplete request, to complete the incomplete request solely on the basis of one or more stored up-to-date data characteristic(s) of one or more current discrete states;
at least one of the modal inputs is continuous, the continuous modal input having a continuous evolution over time, the detection module preferably being configured to detect a discrete state change of the continuous modal input as a function of a current degree of variation of the continuous modal input, the detection module being advantageously configured to detect a discrete state change of the continuous modal input at least if the variation of the continuous modal input remains below a predetermined variation threshold during a predetermined minimum duration, for example at least if the variation is zero during said predetermined minimum duration;
at least one of the modal inputs is discrete, the discrete modal input having a discrete evolution over time, the detection module being configured to detect a discrete state change of the discrete modal input at each variation of the discrete modal input;
the detection module is configured to detect a user request from at least one discrete state change of one of the received modal inputs; and, preferably, the detection module comprises a database of requests and associated trigger conditions, each trigger condition relating to the current discrete state of at least one of the modal inputs, said database advantageously being stored on a file that can be externally configured by an operator;
the detection module is further configured to convert each newly assigned current discrete state following a detected state change and each detected request into a transmission vector and to send said transmission vector to the multimodal interpretation module, each transmission vector presenting a same formatting common to all the transmission vectors sent by the detection module, said common formatting including at least fields, the detection module being configured, for each detected state change, to complete the contents of each field of the associated transmission vector as a function of said data characteristics associated with the newly assigned state following the detected state change, the detection module being configured, for each detected request, to complete the contents of each field of the associated transmission vector as a function of the data characteristics associated with the newly assigned current discrete state following each detected state change from which the request was detected;
the fields comprise a request identification field and at least one essential request field, the content of the request identification field being representative of the fact that the transmission vector is associated with a request, the multimodal interpretation module being configured to determine whether said request is sufficiently complete to be carried out at least if one of the essential fields of the associated transmission vector is empty;
the multimodal interpretation module is configured, in the event of an incomplete request, to complete each empty essential field of the transmission vector associated with the incomplete request, each empty essential field being completed from the content of the corresponding field of the transmission vector associated with the current discrete state of the modal input generated by said other modality;
the detection module is configured to receive at least three distinct modal inputs, the multimodal interpretation module being configured to detect an ambiguity for completing the incomplete request, the ambiguity being between the current discrete states of at least two other modal inputs, said other modal inputs being distinct from each modal input from which the incomplete request was detected, the system further comprising a disambiguation module configured to supply a disambiguation directive to the multimodal interpretation module in the event of a detected ambiguity, the multimodal interpretation module being configured to complete the incomplete request as a function of said disambiguation directive supplied by the disambiguation module, the disambiguation directive preferably comprising an order of priority over the modal inputs for completing the request;
the disambiguation directive comprises a query request from the user, the multimodal interpretation module then being configured to question the user as a function of the query request by means of a human-machine interface;
the multimodal interpretation module is configured to detect an ambiguity between the current discrete states of said at least two other modal inputs, at least when the updated stored data characteristics of said current discrete states, which correspond to the same empty essential field, are contradictory;
the disambiguation directive is stored on a file that can be externally configured by an operator, the file preferably having an xml format;
the disambiguation module stores at least two distinct disambiguation directives, each disambiguation directive being associated with a distinct user, the disambiguation module being configured to supply the disambiguation directive as a function of the user originating the incomplete request;
the control system comprises at least two distinct modalities, each modality comprising a technical means for acquiring at least one sensory information associated with the user, each modality being configured to generate at least one modal input from the sensory information acquired by the technical acquisition means, and being configured to send each generated modal input to the detection module; and, preferably, one of the modalities is an acoustic modality, the detection module being configured to detect a user request from at least one discrete state change of the modal input generated by the acoustic modality, and at least one other of the modalities is chosen from among a tactile modality, an optical modality or a kinesthetic modality, and, preferably at least one further of the modalities is chosen from among a tactile modality, an optical modality or a kinesthetic modality;
the user is a pilot of an aircraft, for example a plane or a drone; and
the multimodal interpretation module is configured to send requests for being carried out, the requests being sent only if they are sufficiently complete to be carried out.

The present disclosure also relates to a control method comprising the following steps:
generation of at least two distinct modal inputs, each modal input being generated from the same modality or from respectively at least two distinct modalities.
detection, for each modal input, of a discrete state change of the modal input from a previously assigned discrete state toward a newly assigned current discrete state of the modal input, and determination of data characteristics of a current discrete state of the modal input following the detected state change;
detecting a user request from at least one of the modal inputs;
the method comprising, on each detected state change of one of the modal inputs, storing and updating data characteristics of the current discrete state of the modal input following the detected state change;
the method comprising, at each detected user request, determining whether said request is sufficiently complete to be carried out, and, in the event of an incomplete request, the incomplete request is then completed from at least one of the stored up-to-date data characteristics of the current discrete state of another modal input distinct from each modal input from which the request was detected.

### BRIEF SUMMARY OF THE DRAWINGS

The present disclosure will be better understood on reading the following description, given by way of example only, and made with reference to the appended drawings, on which:

FIG. 1 is a schematic flowchart of an aircraft comprising a control system according to one embodiment of the present disclosure; and

FIG. 2 is a schematic flowchart of a control method according to one example embodiment of the present disclosure.

### DETAILED DESCRIPTION

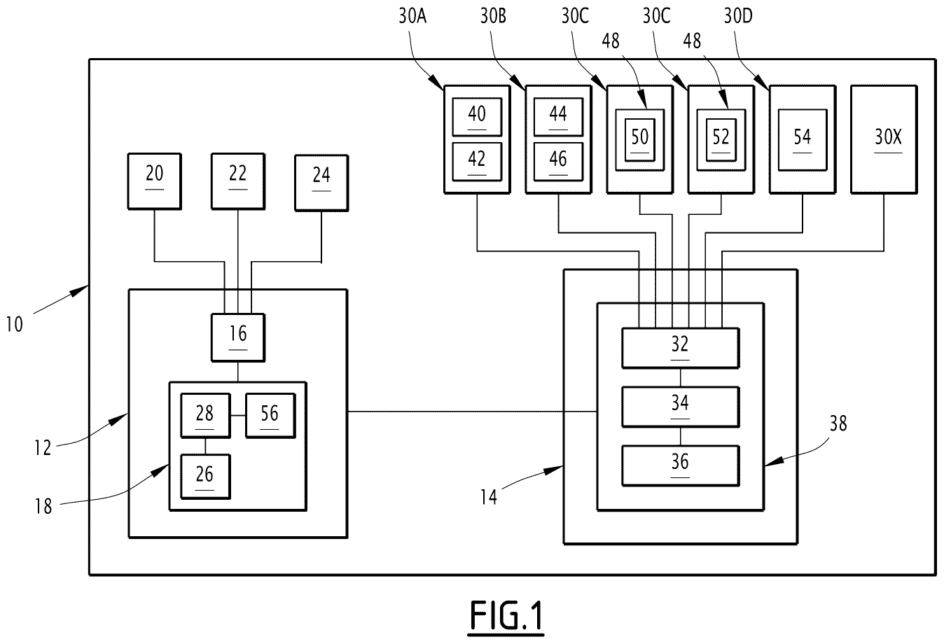

An example of an aircraft 10 is shown in FIG. 1.

The aircraft is, for example, an airplane or a drone.

The aircraft 10 comprises a central avionics system 12.

The aircraft 10 also comprises a control system 14 of a user. The user here is, for example, a pilot of the aircraft 10.

The aircraft 10 also comprises functional systems including, for example, the measuring systems 20 of the aircraft 10, the external communication systems 22, and the control systems 24 for operating the aircraft 10.

The measuring systems 20 include, for example, the components comprising the sensors for measuring parameters external to the aircraft 10, such as temperature, pressure or speed, sensors for measuring parameters internal to the aircraft 10 and its various functional systems, and positioning sensors, such as GPS sensors, inertial units and/or an altimeter.

The external communication systems 22 include, for example, components comprising radio systems, VOR/LOC, ADS, DME, ILS, radar systems, and/or satellite communication systems such as SATCOM.

The control systems 24 are suitable for controlling the flight parameters of the aircraft 10 and the avionic states of the aircraft 10.

The control systems 24 include, for example, components comprising actuators able to operate aircraft 10 controls, such as flaps, rudder, pumps, mechanical, electrical and/or hydraulic circuits, and software actuators.

The various systems 20 to 24 are connected to the central avionics system 12, for example digitally, by means of at least one data bus running on an internal network on the aircraft 10.

The central avionics system 12 includes a central avionics unit 16 and at least one display unit 18, the display unit 18 being located, for example, in the cockpit of the aircraft 10.

The cockpit of the aircraft 10 is located, for example, in the aircraft 10 itself, or in a remote control room of the aircraft 10.

The display unit 18 includes a screen 26 and a display management assembly 28 on the screen 26.

The display management assembly 28 includes, for example, at least one processor and a memory including software modules able to be executed by the processor to manage the display on the screen 26.

The display management assembly 28 is configured to display graphic elements on the screen 26, for example as a function of information coming from the measuring systems 20 and/or the external communication systems 22 and/or the control systems 24.

The control system 14 is connected to the central avionics system 12, by means of a data link.

The data link is, for example, a wired or wireless link.

Generally speaking, the control system 14 comprises at least one modal state change detection module 32 and a multimodal interpretation module 34.

The control system 14 also preferably comprises a disambiguation module 36.

The control system 14 advantageously comprises a processing unit 38 including said modules 32, 34, 36.

The control system 14 preferably comprises at least two distinct modalities 30A-30X.

In one example of the embodiment illustrated in FIG. 1, the control system 14 comprises at least three distinct modalities 30A-30X, preferably at least four distinct modalities or advantageously any number strictly greater than two of distinct modalities. Alternatively, not shown, the control system 14 comprises only two distinct modalities.

Generally speaking, each modality 30A-30X comprises a technical means for acquiring at least one sensory information associated with the user, and each modality 30A-30X is configured to generate at least one modal input from the sensory information acquired by the technical acquisition means.

Each modality 30A-30X generates a single modal input or at least two modal inputs from the same sensory information acquired by the technical acquisition means.

Each piece of sensory information relates to a human sense with which the user can communicate, such as speech, sight, touch, movement or any other sense.

Each modal input generated by each modality 30A-30X evolves over time, as a function of the user and their actions.

Each modality 30A-30X is configured to send each generated modal input to the detection module 32.

Preferably, at least one of the modalities 30A-30X, is configured to generate at least one continuous modal input, the continuous modal input having a continuous evolution over time.

“Continuous” means, for example, that an intermediate state can always be assumed between two successive states of the modal input.

In one example of the embodiment, at least one of the continuous modal inputs presents a continuous variation over time. An example of such a continuous modal input is given below.

In one example of the embodiment, at least one of the continuous modal inputs is able to present a zero variation for a minimum period. An example of such a continuous modal input will be given below.

Preferably, at least one of the modalities 30A-30X is configured to generate at least one discrete modal input, the discrete modal input having a discrete evolution over time.

The term “discrete” is to be understood here as opposed to the term “continuous”.

For example, the discrete evolution is formed by a succession of steps.

Generally speaking, in order to acquire the sensory information and/or generate each modal input, each modality 30A-30X includes, for example, at least one computer processing device operatively connected to a computer memory, for example, a digital signal processor (DSP), a microcontroller, a programmable cell array (FPGA) and/or a dedicated integrated circuit (ASIC) capable of executing various data processing operations and functions.

More specific examples of modalities 30A-30D will now be described. Each of these modalities 30A-30D is separately and individually known to the person skilled in the art.

The said modalities thus preferably comprise at least one acoustic modality 30A, and/or at least one optical modality 30B, and/or at least one tactile modality 30C, and/or at least one kinesthetic modality 30D.

For example, said modalities comprise at least one acoustic modality 30A, at least one optical modality 30B, and at least one tactile modality 30C.

In the example shown in FIG. 1, said modalities comprise at least one acoustic modality 30A, at least one optical modality 30B, and at least two distinct tactile modalities 30C.

Within the scope of the present disclosure, the control system 14 may comprise several distinct modalities of the same type or any other modality 30X conceivable by the person skilled in the art.

Each acoustic modality 30A is configured to acquire an acoustic information from the user and to generate at least one audio modal input from the acquired acoustic information.

To this end, the technical means for acquiring each acoustic modality 30A is an acoustic acquisition device 40.

Each acoustic modality 30A also comprises an audio analysis device 42.

The acoustic acquisition device 40 is configured to acquire said acoustic information from the user.

The acoustic information comprises, for example, sound waves, ultrasonic waves, other vibrations, and/or any combination thereof.

The acoustic acquisition device 40 comprises, for example, at least one microphone and/or any other device capable of acquiring acoustic information.

The audio analysis device 42 is configured to convert the acquired acoustic information into said audio modal input.

The audio analysis device 42 is preferably configured to use speech recognition technology, for example automatic speech recognition (ASR). Such a technology is known to the person skilled in the art and will not be described further here.

The audio analysis device 42 is configured to detect and identify different user sounds in the acquired acoustic information.

The user sounds can include phonetic sounds (for example, words, phrases), emotional sounds (for example, laughter, crying), musical sounds (for example, clapping, humming), other sounds and/or any combination thereof. Preferably, user sounds include words.

The audio modal input is, for example, representative of user sounds, detected and identified by the audio analysis device 42, or of the absence of user sound.

Each optical modality 30B is configured to acquire optical information from the user and to generate at least one optical modal input from the acquired optical information.

To this end, the technical means for acquiring each optical modality 30B is an optical acquisition device 44.

Each optical modality 30B also comprises an optical analysis device 46.

The optical acquisition device 44 is configured to acquire said optical information from the user.

The optical information comprises, for example, electromagnetic radiation belonging to at least part of the electromagnetic spectrum.

Said part of the electromagnetic spectrum includes, for example, at least part of the visible light spectrum, and/or at least part of the infrared spectrum, and/or at least part of the ultraviolet spectrum.

The optical acquisition device 44 comprises, for example, at least one camera, scanner, light sensor, any other device capable of acquiring optical information and/or any combination of these elements thereof.

The optical analysis device 46 is configured to convert the acquired optical information into said optical modal input.

The optical analysis device 46 is preferably configured to use computer vision technology. Such a technology is known to the person skilled in the art and will not be described further here.

The optical analysis device 46 is configured to detect, from the acquired optical information, movement, absence of movement, spatial orientation, spatial location, and/or any combination of this information thereof, of at least one part of the body of the user.

The body parts of the user comprise, for example, a hand, a head, a face, an eye, a mouth, any other part of the body of the user and/or any combination of these parts.

The movement of the parts of the body can be used to communicate and can include hand movements (for example, gestures, sign language), head movements (for example, nodding), facial movements (for example, smiling), eye movements (for example, blinking, looking in a specific direction), mouth movements (for example, lip-reading), other movements and/or any combination of these movements thereof.

In a preferred example of the embodiment, the optical modal input is representative of a zone pointed to by at least one part of the body of the user. For example, the zone pointed to is a zone of a display, for example a zone of the screen 26 of the display unit of the central avionics system 12.

The optical modal input is then in this example continuous, and for example presents a continuous variation over time.

Indeed, the body parts of the user (such as the eyes) present continuous movement.

In one example of the embodiment, the optical acquisition device 44 and the optical analysis device 46 of the optical modality 30B form an eye tracker device. The body part is then an eye of the user, and said pointed zone is the zone looked at by the eye.

The optical modal input includes, for example, a two-dimensional or three-dimensional format. Each optical modal input comprises, for example, at least two positioning parameters for the zone pointed to which vary over time.

Each tactile modality 30C is configured to acquire a tactile information from the user and to generate at least one tactile modal input from the acquired tactile information.

To this end, the technical means for acquiring each tactile modality 30C is a tactile acquisition device 48.

Each tactile modality 30C also comprises a tactile analysis device.

Each tactile acquisition device 48 is configured to acquire said tactile information from the user.

At least one of the tactile acquisition devices 48 is, for example, included in a human-machine interface of the central avionics system 12.

Each tactile acquisition device 48 comprises, for example, a keypad, a pushbutton, and/or a pointing device and/or any combination of these elements thereof.

Each keyboard comprises at least one key, for example hardware or software.

Each pointing device comprises, for example, a computer mouse, a joystick 50 such as for example a joystick, a touchpad, and/or a touchscreen 52, and/or any combination of these elements thereof.

In the case of a tactile modality 30C comprising a keyboard or pushbutton, the tactile modal input is, for example discrete.

In the example shown in FIG. 1, the control system 14 comprises two distinct tactile modalities 30C. The tactile acquisition device 48 of a first tactile modality 30C comprises a joystick 50 and the tactile acquisition device 48 of a second tactile modality 30C comprises a touch screen 52.

The tactile analysis device is configured to convert the acquired tactile information into said tactile modal input.

In the case of a tactile modality 30C in which the tactile acquisition device 48 comprises a pointing device (such as the joystick 50 or the touch screen 52 of FIG. 1), the tactile modal input is representative of a zone pointed to by the user. For example, the zone pointed to is a zone of a display, for example, a zone of the screen 26 of the central avionics system 12 display unit.

In this example, the tactile modal input is continuous.

The tactile modal input includes, for example, a two-dimensional or three-dimensional format. Each tactile modal input comprises, for example, at least two positioning parameters for the zone pointed to that vary over time.

Each kinesthetic modality 30D is configured to acquire a kinesthetic information from the user and to generate at least one kinesthetic modal input from the acquired kinesthetic information.

To this end, the technical means for acquiring each kinesthetic modality 30D is a kinesthetic acquisition device 54.

Each kinesthetic modality 30D also comprises a kinesthetic analysis device.

Each kinesthetic acquisition device 54 is configured to acquire kinesthetic information from the user.

The kinesthetic information comprises, for example, movement, lack of movement, spatial orientation, spatial location, and/or any combination of this information of at least one part of the body of the user.

The parts of the body of the user include, for example, a hand, a head, a face, a mouth, any other part of the body of the user and/or any combination of these parts.

Each kinesthetic acquisition device 54 comprises, for example, at least an accelerometer, a gyroscope, a proximity sensor, and/or any combination thereof.

The kinesthetic analysis device is configured to convert the acquired kinesthetic information into said kinesthetic modal input.

Thus, the kinesthetic modal input is, for example, similar to what is described above for the optical modal input. The kinesthetic modality 30D differs from the optical modality 30B in that the technical means of acquisition implemented are distinct.

The processing unit 38 comprises, for example, a computer processing device operatively connected to a computer memory, for example, a digital signal processor (DSP), a microcontroller, a programmable cell array (FPGA) and/or a dedicated integrated circuit (ASIC) capable of executing various data and function processing operations, in particular capable of executing at least the functions of the modules described below.

The computer processing device comprises, for example, a single processor. Alternatively, the computer processing device comprises several processors, which are located in the same geographical zone, or are, at least partially, located in different geographical zones and are then able to communicate with each other.

At each occurrence of the term “memory”, it is understood to mean any volatile or non-volatile computer memory appropriate to the subject matter currently disclosed, such as random access memory (RAM), read-only memory (ROM) or other electronic, optical, magnetic or any other computer-readable storage medium on which the data and functions of the modules described herein are stored, for example.

Accordingly, the memory is a tangible storage medium where the data and functions of the modules described herein are stored in non-transitory form, for example.

The detection module 32 is configured to receive each modal input generated by each modality.

The detection module 32 is thus configured to receive, over time, the evolution of each modal input generated by each modality.

The detection module 32 is configured to process the modal inputs generated by each modality in parallel, in other words, separately and simultaneously.

In other words, the detection module 32 is able to allow the multimodal interpretation module 34 to be generic and adaptable to any type of modality and to any number of distinct modalities, in other words, adaptable, for example, to the or each acoustic modality 30A, and/or to the or each optical modality 30B, and/or to the or each tactile modality 30C, and/or to the or each kinesthetic modality 30D, and/or to any other modality 30X as appropriate.

The detection module 32 is configured, for each modal input, to detect a discrete state change of the modal input from a previously assigned discrete state to a newly assigned current discrete state of the modal input, and to determine data characteristics of the current discrete state of the modal input as a result of the detected state change.

The current discrete state corresponds to a new discrete state that differs from the previously assigned discrete state.

Detection takes place in real time, for example during piloting of the aircraft, particularly during the flight of the aircraft.

The discrete state change is detected as a function of at least one detection criterion.

Preferably, the detection module 32 is configured, for each modal input, to assign a current discrete state to the modal input chosen from a list of at least two possible discrete states.

The newly assigned current discrete state is, in particular, selected from the list of possible discrete states.

Each possible discrete state is associated, for example, with its own detection criterion.

In a preferred embodiment, for each modal input, each detection criterion and each associated possible discrete state are stored in a file that can be configured externally by an operator.

The set of detection criteria and possible discrete states are able to be modified prior to operation of the control system 14 by the user, in particular, by adding in case of new possible discrete states for any modal input generated by this new modality, when a new modality is to be integrated into the control system. The said set is then able to be loaded into the detection module 32.

Thus, the detection module 32 can be easily adapted to any new modality.

The detection module 32 is configured to assign and detect a current discrete state change of the modal input, independent of the nature of the evolution of the modal input (continuous or discrete in particular).

In other words, the detection module 32 only assigns and detects discrete state changes, even though the modal input may be evolving continuously.

More specific examples of detection for modal inputs will now be described.

In the case of an acoustic modality 30A generating an audio modal input, the associated possible discrete states comprise states corresponding respectively to language elements able to be interpreted in the detected and identified user sounds of the audio modal input.

The language elements preferably correspond to a user intention or an element designated by the user.

For each of these possible discrete states, the associated detection criterion thus corresponds at least to the recognition of at least one language element interpreted in the detected and identified user sounds of the audio modal input.

To achieve this, the detection module 32 is configured, for example, to implement NLU (Natural Language Understanding) processing. Such processing is able, for example, to determine at least one interpreted language element corresponding to a user intention or an element designated by the user, from the detected and identified user sounds of the audio modal input.

The detection module 32 assigns the current discrete state corresponding to the interpreted language element(s) in the audio modal input.

The data characteristics of each possible discrete state is then, for example, representative of the interpreted language element(s).

The data characteristics then includes, for example, a material or virtual element vocally designated by the user or as detailed below, a vocal user request.

The possible discrete states associated with the audio modal input also preferably comprise at least one state corresponding to an absence of user sounds or an absence of interpretation.

Thus, when the audio analysis device 42 no longer detects user sounds or the natural language understanding NLU process no longer interprets the language element(s), the detection module 32 also detects a state change as the audio modal input varies, and the detection module 32 assigns a current discrete state corresponding to an absence of user sounds or an absence of interpretation.

The data characteristics of this current discrete state is then, for example, representative of an absence of user sounds or an absence of interpretation.

In the case of a tactile modality 30C comprising a keypad or pushbutton generating a tactile modal input, the associated possible discrete states comprise states corresponding respectively to the actuation of each key on the keypad or the actuation of the pushbutton.

For each of these possible discrete states, the associated detection criterion thus corresponds to at least the actuation of the associated key or pushbutton.

Thus, the detection module 32 detects a discrete state change of the tactile modal input each time the keypad or pushbutton is actuated. The detection module 32 assigns the current discrete state corresponding to the actuated key or pushbutton to the tactile modal input.

The data characteristics of this current discrete state are then, for example, representative of said actuation.

The possible discrete states associated with the tactile modal input also preferably include at least one state corresponding to an absence of actuation.

Thus, when the user no longer actuates the keypad or pushbutton, the detection module 32 also detects a state change of the tactile modal input and assigns the current discrete state corresponding to an absence of actuation to the tactile modal input.

The data characteristics of this current discrete state are then, for example, representative of an absence of actuation.

In the case of a tactile modality 30C comprising a pointing device, such as a joystick 50 or a touch screen 52, generating a tactile modal input representative of a pointed zone, the associated possible discrete states comprise at least one state corresponding to pointing at a target.

The target is, for example, a virtual element displayed on the screen 26.

Preferably, the associated detection criterion relates to a variation of the tactile modal input, for example to a degree of current variation of the tactile modal input.

The detection criterion associated with the pointing state is verified, for example, at least if the variation of the tactile modal input relative to a target remains below a predetermined variation threshold for a predetermined non-zero minimum duration.

The pointed target is, for example, fixed relative to a reference, the reference corresponding, for example, to the edges of the screen 26. The variation threshold is then, for example, zero.

In other words, the detection module 32 detects a discrete state change of the tactile modal input when the pointing device is no longer moving and therefore the absolute variation of the associated tactile modal input is zero. The detection module 32 assigns the current discrete state corresponding to the pointing of the fixed target to the tactile modal input.

The pointed target is, for example, movable relative to the reference. The variation threshold is then, for example, non-zero, to take into account any variation of the pointing device around the movable pointing target.

In other words, the detection module 32 detects a discrete state change of the tactile modal input when the pointing device moves and follows a moving target, the relative variation of the tactile modal input with respect to the pointed target being below the non-zero variation threshold. The detection module 32 assigns the current discrete state corresponding to the pointing of the moving target to the tactile modal input.

The data characteristics of the current discrete pointing state are then, for example, representative of the pointed target, for example, the positioning parameters of said pointed target.

The possible discrete states associated with said tactile modal input also preferably include at least one state corresponding to an absence of pointing.

In particular, the detection criterion associated with the absence of pointing state is verified at least if the variation of the continuous modal input passes above said predetermined variation threshold.

Thus, when the pointing device varies from the previously pointed zone or target, the detection module 32 detects a state change as the variation of the optical modal input passes above the variation threshold. In particular, the detection module 32 detects a state change and assigns the current discrete state in the absence of pointing to the tactile modal input.

The data characteristics of this current discrete state are then, for example, representative of an absence of a pointed zone.

In a preferred alternative, the absence of a pointing state is associated with another detection criterion, which is verified at least if the target remains pointed beyond a predetermined non-zero maximum duration.

In other words, the detection module 32 detects a discrete state change of the tactile modal input when the pointing device no longer moves beyond the predetermined non-zero maximum duration. The detection module 32 assigns the current discrete state during the absence of pointing to the tactile modal input.

Such a detection criterion subsequently allows the multimodal interpretation module to ignore the target pointed at by the pointing device, beyond a certain duration.

In the case of an optical modality 30B comprising an eye-tracking device generating an optical modal input representative of a zone pointed at by the eye of the user, the associated possible discrete states comprise at least one state corresponding to pointing at a target.

The target is, for example, a virtual element displayed on the screen 26.

Preferably, the associated detection criterion relates to a variation in the optical modal input, for example a current degree of variation in the optical modal input.

For example, the detection criterion associated with the pointing state is verified at least if the variation of the optical modal input relative to a target remains below a predetermined variation threshold for a predetermined minimum non-zero duration.

The variation threshold is, for example, then non-zero, to take into account the continuous movement of the eye even when it points at the target.

The target pointed at is, for example, fixed relative to a reference, the reference corresponding, for example, to the edges of the screen 26.

In other words, the detection module 32 detects a state change of the optical modal input when the eye no longer substantially moves, and therefore when the eye of the user is fixed at a specific zone for a prolonged period, in other words, for a predetermined minimum duration. The detection module 32 assigns the current discrete state corresponding to the pointing of the fixed target to the optical modal input.

The pointed target is, for example, movable relative to the reference.

In other words, the detection module 32 detects a discrete state change of the optical modal input when the eye moves and tracks a moving target, the relative variation of the optical modal input relative to the pointed target being below the non-zero variation threshold. The detection module 32 assigns the current discrete state corresponding to the pointing of the movable target to the optical modal input.

The data characteristics of the current discrete pointing state are then, for example, representative of the pointed target, for example, the positioning parameters of said pointed target.

The possible discrete states associated with said optical modal input also preferably comprise at least one state corresponding to an absence of pointing.

In particular, the detection criterion associated with the absence of the pointing state is verified at least if the variation of the optical modal input passes above said predetermined variation threshold.

Thus, when the eye of the user varies from the previously pointed zone or target, the detection module 32 detects a state change as the variation of the optical modal input rises above the predetermined threshold of variation. In particular, the detection module 32 detects a state change and assigns a current discrete state, in the absence of pointing, to the optical modal input, in which the eye of the user is not pointing at any specific zone.

The data characteristics of this current discrete state are then, for example, representative of an absence of a pointed zone.

The detection module 32 is also configured to detect an intentional user request from at least one of the modal inputs received.

The request relates to an action on at least one object.

The request is, for example, an information request relating to the object, the action being the request for information. The information request is, for example, of the open type and calls for a response other than yes/no.

The request is, for example, a command from the user concerning the object, the action being the command.

The command aims, for example, to intervene on the said object in order to modify at least one flight parameter of the aircraft 10 during flight and/or at least one avionics state of the aircraft 10, by means of at least one of the control systems 24.

Any other request could be considered within the scope of the present disclosure.

Any type of method for detecting such a request is conceivable within the scope of the present disclosure.

Preferably, the detection module 32 is configured to detect such a request from at least one discrete state change of one of the modal inputs received.

The detection of such a request takes place in real time, for example during the flight of the aircraft.

To detect a request, the detection module 32 comprises, for example, a database of requests and associated trigger conditions.

In a preferred embodiment, said database is stored on a file that can be configured externally by an operator.

The set of requests and associated trigger conditions are able to be modified by the user prior to operation of the control system 14 and are then able to be loaded into the detection module 32.

Each trigger condition preferably relates to at least one possible discrete state of at least one of the modal inputs.

The detection module 32 is configured, for example, to compare, with said database, the newly assigned current discrete state following each detected state change of at least one of the modal inputs.

At least one request, for example, is detected unimodally.

The said request is then detected by one or more unimodal trigger conditions relating to only one of the modal inputs, in other words, relating to a state change of only one of the modal inputs.

The unimodal trigger conditions include, for example, an acoustic trigger condition relating to at least one discrete state change of the audio modal input. For example, the acoustic trigger condition relates to a user intention, or an element designated by the user forming data characteristics of the assigned current discrete state of the audio modal input following a state change of the audio modal input.

In other words, the detection module 32 is configured to detect a user request from at least one discrete state change of the audio modal input generated by the acoustic modality 30A.

The unimodal trigger conditions also include, for example, at least one tactile trigger condition, an optical trigger condition and/or a kinesthetic trigger condition.

For example, at least one request is detected multimodally. Said request is then detected by at least two unimodal trigger conditions, each relating to two distinct modal inputs, for example two modal inputs generated by two distinct modalities.

The detection module 32 is configured to send each newly assigned current discrete state following a detected state change, and each detected request to the multimodal interpretation module 34.

The detection module 32 is thus interposed between the multimodal interpretation module 34 and each modality and sends the elements to the multimodal interpretation module 34 only on state change of the modal inputs.

To do this, in one preferred embodiment, the detection module 32 is configured to convert each newly assigned current discrete state following a detected state change and each detected request into a transmission vector and to send said transmission vector to the multimodal interpretation module 34.

Advantageously, each transmission vector presents the same formatting common to all transmission vectors sent by the detection module 32 to the multimodal interpretation module 34.

In particular, the formatting is the same whether the transmission vector is associated with a detected request or with a detected state change that is not associated with any request.

In other words, all modal inputs are managed using the same formalism. It is possible to have a control system 14 architecture that remains generic, without depending on the nature of the modalities considered. In particular, modalities can be easily added or deleted.

Common formatting can be configured using an external file.

Therefore, the common formatting includes at least request and status change fields.

The detection module 32 is configured, for each detected state change, to complete the content of each field of the associated transmission vector as a function of said data characteristics associated with the newly assigned current discrete state following the detected state change.

In addition, the detection module 32 is configured, for each detected request, to complete the content of each field of the associated transmission vector as a function of the data characteristics associated with the newly assigned current discrete state following each detected state change from which the request was detected.

In particular, in each case, the detection module 32 is configured to determine, from among these data characteristics, the data relevant to the content of each field.

The detection module 32 is configured, for example, to complete all fields not corresponding to any of the data characteristics with information representative of an empty character in the field.

The fields comprise, for example, at least one field storing information representative of the original modal input.

The fields preferably comprise a request identification field.

The content of the request identification field is representative of whether the transmission vector is associated with a request or not.

The content of the request identification field is also, for example, representative of the action forming the detected request, if any (for example, the fact that a distance is requested).

The fields preferably comprise at least one essential request field for implementing the request.

In particular, as will be explained later, in the event that at least one of the essential fields stores information representative of the field being empty, the request is incomplete and cannot be carried out.

In one embodiment, the essential fields comprise, for example, at least one field relating to an identification of the object concerned (for example, the object the distance of which the user wishes to know) and, for example, a field relating to a type of object concerned.

For example, the fields also comprise at least one non-essential field for implementing the request.

For example, such a non-essential field relates to additional complementary information about the object concerned by the request.

The multimodal interpretation module 34 is interposed between the detection module 32 and the central avionics system 14.

The multimodal interpretation module 34 is configured to send requests to the central avionics system 14 for being carried out, the requests being sent to the central avionics system 14 only if they are sufficiently complete to be carried out.

To do this, the multimodal interpretation module 34 is configured, on each detected state change of one of the modal inputs, to store and update data characteristics of the newly assigned current discrete state of the modal input following the detected state change.

In other words, for each modal input, the multimodal interpretation module 34 is configured to store in memory the last discrete state change that took place for the modal input.

In particular, for each state change detected by the detection module 32, the multimodal interpretation module 34 is configured to receive each associated transmission vector and to update said data characteristics of the newly assigned current discrete state as a function of the transmission vector.

In one alternative embodiment, the multimodal interpretation module 34 is configured to store a history of successively assigned current discrete states over time.

The multimodal interpretation module 34 is configured, for each detected user request, to determine whether said request is sufficiently complete to be carried out.

In one example embodiment, the multimodal interpretation module 34 is configured to determine whether said request is sufficiently complete to be carried out at least if one of the essential fields of the associated transmission vector is empty.

In the event of an incomplete request, the multimodal interpretation module 34 is configured to complete the incomplete request from at least one of the stored up-to-date data characteristics of the current discrete state of another modal input, for example a modal input generated by another modality. The other modal input, and if applicable the other modality, is distinct from the one(s) from which the request was detected.

More specifically, the multimodal interpretation module 34 is configured to compare the incomplete request with the stored up-to-date data characteristics of the current discrete state of each other modal input.

The request is completed following this comparison.

In one example of the embodiment, the multimodal interpretation module 34 is configured to complete the incomplete request solely from one or more of the stored up-to-date data characteristics of one or more of current discrete state(s).

In other words, the multimodal interpretation module 34 does not require a time window to complete the requests, but is based on updated discrete states, in other words, on the latest detected state changes of the modal inputs.

Thus, in the event of an incomplete request, the multimodal interpretation module 34 is configured to complete the incomplete request without necessarily determining a complex time window for the modal inputs.

Alternatively, the multimodal interpretation module 34 is configured to complete the incomplete request from one or more stored up-to-date data characteristic(s) of one or more current discrete states, from a time window comprising a time correlation between the different modal inputs. Such a time window is determined, for example, by the detection module 32.

In one example of the embodiment, the multimodal interpretation module 34 is configured to complete the incomplete request by completing each empty essential field of the transmission vector associated with the incomplete request.

Each essential empty field is completed from the content of the corresponding field associated with the current discrete state of said other modal input.

The multimodal interpretation module 34, for example, is able to use the current discrete states of at least two distinct modal inputs to respectively complete different empty essential fields of the incomplete request.

After completing the previously incomplete request, the multimodal interpretation module 34 is configured to send the completed request to the central avionics system 14 for being carried out.

In one advantageous embodiment in which the or all modalities generate a total of at least three distinct modal inputs which are received by the detection module 32, the multimodal interpretation module 34 is further configured to detect an ambiguity to complete the incomplete request.

This is, for example, the example shown in FIG. 1, in which at least three distinct modalities respectively generate at least one modal input.

The ambiguity detected is an ambiguity between the current discrete states of at least two other modal inputs, for example generated respectively by two other modalities, said other modal inputs being distinct from the one(s) from which the incomplete request was detected.

To do this, the multimodal interpretation module 34 is configured, for example, to detect such an ambiguity following comparison of the incomplete request with the stored up-to-date data characteristics of the current discrete state of each other modal input.

The ambiguity is detected at least when the stored up-to-date data characteristics of at least two current discrete states, which correspond to the empty essential field associated with the incomplete request, are contradictory.

If ambiguity is detected, the multimodal interpretation module 34 is configured to call up the disambiguation module 36.

The disambiguation module 36 is configured to provide a disambiguation directive to the multimodal interpretation module 34 if ambiguity is detected.

In particular, the disambiguation module 36 stores said disambiguation directive.

The disambiguation directive preferably comprises an order of priority on the modal inputs to complete the request.

The disambiguation directive comprises, in addition or alternatively, a query request from the user. In one embodiment, the query request is part of the order of priority.

In one preferred embodiment, the disambiguation directive is stored on a file that can be configured externally by an operator.

The file presents an xml format, for example.

Thus, the file is able to be modified by the user prior to operation of the control system 14, in particular as a function of their preferences, and can then be loaded into the disambiguation module 36.

Preferably, the disambiguation module 36 stores at least two distinct disambiguation directives, each disambiguation directive being associated with a distinct user.

Preferably, the disambiguation module 36 stores as many distinct disambiguation directives as there are distinct users.

The disambiguation module 36 is configured to provide the disambiguation directive as a function of the user originating the incomplete request.

For example, the two distinct directives present distinct orders of priority.

Following the provision of the disambiguation directive, the multimodal interpretation module 34 is configured to complete the incomplete request as a function of said provided disambiguation directive.

In particular, the multimodal interpretation module 34 completes the incomplete request by following the order of priority on the modal inputs.

More precisely, the multimodal interpretation module 34 is configured to complete the empty essential field with the content of the corresponding non-empty field associated with the current discrete state of the modal input given by the order of priority.

Furthermore, if the disambiguation directive includes a query request from the user, the multimodal interpretation module 34 is then configured to question the user as a function of the query request, for example by means of the central avionics system 14, which then includes a human-machine interface 56 for this purpose.

The central avionics system 14 is able to acquire the response from the user to the query request and send the acquired response to the multimodal interpretation module 34.

The multimodal interpretation module 34 is able to complete the incomplete request as a function of the acquired response.

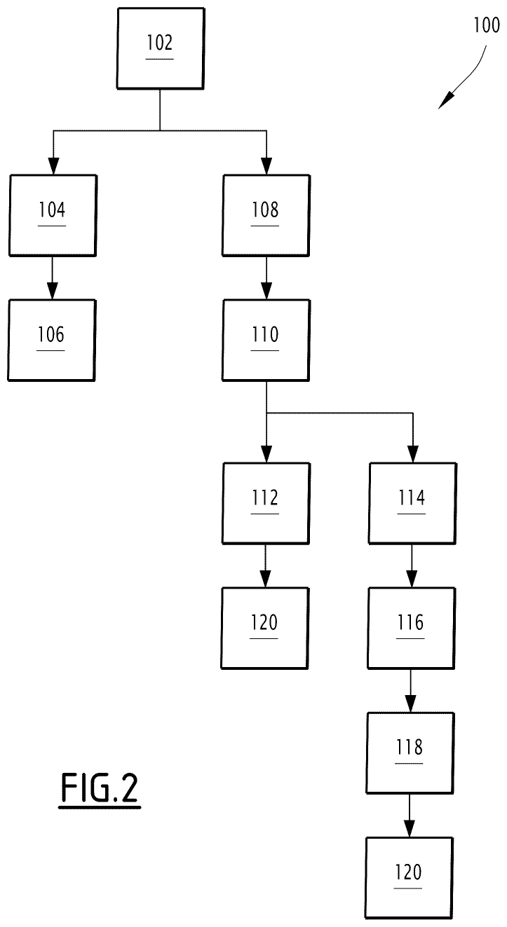

A control method 100 will now be described with reference to FIG. 2.

The control method 100 is, for example, implemented by computer and in particular by the control system 14 described above. The control method 100 then comprises providing 102 the control system 14 described above.

The method 100 comprises implementing the functions of the various modules 32, 34, 36 described above.

The method 100 comprises generating at least two distinct modal inputs, each modal input being generated from the same modality or from at least two distinct modalities respectively.

Each modal input generated by each modality 30A-30X evolves over time, as a function of the user and his actions.

The method 100 comprises detecting 104, for each modal input, a discrete state change of the modal input from a previously assigned discrete state toward a newly assigned current discrete state of the modal input and determining data characteristics of the current discrete state of the modal input following the detected state change.

More specifically, the assignment step 104 comprises, for each modal input, detecting a discrete state change of the modal input from a previously assigned discrete state toward a new current discrete state.

The detection 104 is performed in a similar way to that described above for the functions of the detection module 32.

The detection 104 takes place in real time, for example during the flight of the aircraft.

The method 100 comprises, at each detected state change of one of the modal inputs, a step 106 of storing and updating data characteristics of the current discrete state of the modal input following the detected state change.

The method 100 also comprises detecting 108 a user request from at least one of the modal inputs.

Any type of method for detecting such a request is conceivable within the scope of the present disclosure.

Preferably, the detection 108 of a request is from at least one discrete state change of the modal input generated by one of the modalities.

The detection 108 is performed in a similar way to that described above for the functions of detection module 32.

The detection 108 takes place in real time, for example during the flight of the aircraft.

The method 100 further comprises, for each detected user request, a step 110 of determining whether said request is sufficiently complete to be carried out.

In the event of an incomplete request, the incomplete request is then completed (step 112) from at least one of the stored up-to-date data characteristics of the current discrete state of another modal input, the other modal input being distinct from that from which the request was detected.

The step 106 of storing and updating, the step 110 of determining and the step 112 in which the incomplete request is completed are done in a similar way to what has been described above for the functions of the multimodal interpretation module 34.

In one advantageous embodiment in which the modality set(s) generate(s) a total of at least three distinct modal inputs, the method 100 further comprises detecting 114 an ambiguity for completing the incomplete query, and providing 116 a disambiguation directive, the incomplete request being completed (step 118) as a function of said provided disambiguation directive.

These steps 114, 116 are performed in a similar way to what has been described above for the functions of the disambiguation module 36.

After completion, the previously incomplete request is sent to the central avionics system 14 for being carried out (step 120).

More specific examples will now be described in the context of the aircraft 10 in FIG. 1.

The user is a pilot of the aircraft 10, and the screen 26 displays the waypoints.

A first example corresponds to the situation in which the touchscreen 52 is not manipulated by the user, the joystick 50 is not pointing at any precise zone or is pointing at a zone with no virtual element, the user fixes one of the waypoints displayed on the screen 26, designated by the term waypoint 1, and the pilot says “how far is it to the waypoint?”.

The detection module 32 then detects a state change of the optical modal input from a state corresponding to an absence of pointing, toward a current discrete state corresponding to the pointing of a target fixed by the eye of the user, which in this case is a precise zone of the screen 26 including the virtual element corresponding to the waypoint 1. The characteristic data of this current discrete state includes the waypoint 1 located in the zone pointed to by the eye.

The detection module 32 does not detect any user request from this optical modal input, as this state change does not correspond, in this particular example, to any trigger condition.

The associated transmission vector sent by the detection module 32 includes, in this example, the following fields:
Modal input: optical
Request identifier: empty
Type of object concerned: waypoint
Object identifier concerned: waypoint 1
Additional information about the object concerned: Empty

The multimodal interpretation module 34 stores and updates accordingly the data characteristics of the current discrete state of the optical modal input following this detected state change.

The audio analysis device 42 detects and identifies, in parallel, various user sounds in the acquired acoustic information corresponding here to the sequence of terms “what is the distance to the waypoint?” and forming the audio modal input.

By using the NLU natural language understanding processing, the detection module 32 identifies the language elements in this audio modal input, corresponding here to a distance request, and to a type of object concerned by the request, in this case a waypoint.

The detection module 32 then detects in parallel a state change of the audio modal input from a previously assigned discrete state corresponding to an absence of user sounds or an absence of interpretation, toward a current discrete state corresponding to the language elements interpreted in the audio modal input. The data characteristics of this current discrete state are then representative of these interpreted language elements.

The detection module 32 detects a user request from the audio modal input, and in particular from this detected state change of the audio modal input. This request is detected from the comparison of this detected state change of the audio modal input with the request database, at least one of the interpreted language elements being recognized as one of the trigger conditions of the database.

In this example, the transmission vector associated with the request sent by the detection module 32 includes the following fields:
Modal input: audio
Request identifier: distance
Type of object concerned: waypoint
Object identifier: empty
Additional information about the object concerned: Empty

The multimodal interpretation module 34 determines that the request is not sufficiently complete to be carried out, as the essential field corresponding to the identifier of the object concerned is empty.

The multimodal interpretation module 34 completes the incomplete request from only the stored current data characteristics of the current discrete state of the optical modal input.

The current data characteristics of the updated discrete states of the other modal inputs, in this case the two tactile modal inputs associated with the joystick 50 and the touch screen 52, do not allow the request to be completed.

Indeed, the current discrete states stored by the multimodal interpretation module 34 for the modal inputs associated with the joystick 50 and the touch screen 52 are states corresponding to an absence of pointing.

The multimodal interpretation module 34 completes the essentially empty object identifier field with the data characteristic “waypoint 1” of the current discrete state of the optical modal input.

The multimodal interpretation module 34 sends the complete request, corresponding to the request “what is the distance to waypoint 1?”, to the central avionics system 14.

The central avionics system 14 implements the complete request provided by the multimodal interpretation module 34. In this case, the central avionics system 14 provides the user with a response to the completed request.

A second example corresponds to the situation during which the touch screen 52 is not manipulated by the user, the user is looking at one of the waypoints displayed on the screen 26, referred to as waypoint 1, and has manipulated the joystick 50 to point at another of the waypoints displayed on the screen 26, referred to as waypoint 2, and the pilot says “what's the distance to the waypoint?”.

The optical modal input is processed as in the first example.

The detection module 32 then detects in parallel a state change of the tactile modal input associated with the joystick 50 from a state corresponding to an absence of pointing, toward a current discrete state corresponding to pointing at a target, which here is a precise zone of the screen 26 including the virtual element corresponding to the waypoint 2. The detection has been made because the joystick 50 presents a zero variation relative to said waypoint 2. The data characteristics of this current discrete state include the waypoint 2 located in the zone pointed to by the joystick 50.

The associated transmission vector sent by the detection module 32 includes, in this example, the following fields:
Modal input: tactile—joystick
Request identifier: empty
Type of object concerned: waypoint
Object identifier: waypoint 2
Additional object information: Empty

The multimodal interpretation module 34 stores and updates accordingly the data characteristics of the current discrete state of the tactile modal input associated with the joystick 50 following this detected state change.

As in the first example, the multimodal interpretation module 34 determines that the request associated with the acoustic modality 30A is not sufficiently complete to be carried out, insofar as the essential field corresponding to the identifier of the object concerned is empty.

However, the multimodal interpretation module 34 detects an ambiguity and completes the incomplete request. Indeed, the stored up-to-date data characteristics of the current discrete state of the optical modal input and the current discrete state of the tactile modal input associated with the joystick 50 are contradictory, between the waypoint 1 and waypoint 2.

The multimodal interpretation module 34 then calls on the disambiguation module 36, which provides a disambiguation directive.

In one embodiment, the disambiguation directive comprises an order of priority, in which the optical modality 30B has priority over the tactile modality 30C.

As a result, the multimodal interpretation module 34 completes the essentially empty field of the object identifier concerned with the “waypoint 1” data characteristics of the current discrete state of the optical modal input.

The multimodal interpretation module 34 sends the complete request, corresponding to the request “what is the distance to waypoint 1?”, to the central avionics system 14.

The central avionics system 14 implements the complete request provided by the multimodal interpretation module 34. In this case, the central avionics system 14 provides the user with a response to the completed request.

In another embodiment, the disambiguation directive comprises a query request from the user.

Accordingly, the multimodal interpretation module 34 queries the user as a function of the query request, by means of the central avionics system 14. The central avionics system 14 acquires the response from the user to the query request and sends the acquired response to the multimodal interpretation module 34.

The multimodal interpretation module 34 is able to complete the incomplete request corresponding to the acquired response. For example, if the response from the user is to prioritize the tactile modal input associated with the joystick 50, the multimodal interpretation module 34 completes the essential empty field of the object identifier concerned with the data characteristics “waypoint 2” of the current discrete state of the tactile modal input 30C associated with the joystick 50.

The multimodal interpretation module 34 then sends the complete request, corresponding to the request “what is the distance to waypoint 2?”, to the central avionics system 14.

Thanks to the features described above, the system of the present disclosure is based on a modal input management mechanism detecting state changes and operating on the basis of discrete current states assigned to complete user requests, without the need to use a time window to temporally correlate modal inputs with each other. This drastically simplifies multimodality management.

It is still possible for the control system to take into account a temporality between modal inputs, but this is not necessary for the management of modal inputs in the present disclosure.

In addition, the system of the present disclosure presents a multimodality architecture, corresponding to the modules 32 and 34, which can take as many different modalities as required as inputs, in a generic way.

The modules 32 and 34 form a multimodality architecture that is functionally independent of the part of the system that applies the control. It can therefore be easily adapted to an existing system, without modifying the architecture of that existing system.

In addition, the system of the present disclosure is also preferably based on a configurable disambiguation mechanism, allowing ambiguous situations to be managed by prioritizing the modalities, relative to one another and allowing to know when to question the user to disambiguate.

What is claimed is:

1. A control system comprising:
a modal state change detection module configured to receive at least two distinct modal inputs, each modal input being generated from a same modality or from respectively at least two distinct modalities,
the detection module being configured, for each modal input received, to detect a discrete state change of the modal input from a previously assigned discrete state toward a newly assigned current discrete state of the modal input and to determine data characteristics of the current discrete state of the modal input following the detected state change;
the detection module further being configured to detect a user request from at least one of the modal inputs received; AND
a multimodal interpretation module configured, at each detected state change of one of the modal inputs, to store and update data characteristics of the current discrete state of the modal input following the detected state change;
the multimodal interpretation module further being configured, on each detected user request, to determine whether said request is sufficiently complete to be carried out, and, in an event of an incomplete request, to complete the incomplete request from at least one of the stored up-to-date data characteristics of the current discrete state of another modal input distinct from each modal input from which the request was detected.

2. The control system according to claim 1, wherein each discrete state change is detected as a function of at least one detection criterion.

3. The control system according to claim 2, wherein the newly assigned current discrete state is selected from a list of at least two possible discrete states; and/or wherein each detection criterion and each possible discrete state is stored on a file externally configurable by an operator.

4. The control system according to claim 1, wherein the multimodal interpretation module is configured, in the event of an incomplete request, to complete the incomplete request solely from stored up-to-date data characteristics of the current discrete state(s).

5. The control system according to claim 1, wherein at least one of the modal inputs is continuous, the continuous modal input having a continuous evolution over time, the detection module being configured to detect a discrete state change of the continuous modal input as a function of a current degree of variation of the continuous modal input.

6. The control system according to claim 5, wherein the detection module is configured to detect a discrete state change of the continuous modal input at least if the variation of the continuous modal input remains below a predetermined threshold variation during a predetermined minimum duration.

7. The control system according to claim 1, wherein at least one of the modal inputs is discrete, the discrete modal input having a discrete evolution over time, the detection module being configured to detect a discrete state change of the discrete modal input at each variation of the discrete modal input.

8. The control system according to claim 1, wherein the detection module is configured to detect a user request from at least one discrete state change of one of the received modal inputs.

9. The control system according to claim 8, wherein the detection module comprises a database of requests and associated trigger conditions, each trigger condition relating to the current discrete state of at least one of the modal inputs.

10. The control system according to claim 9, wherein said database is stored on a file that can be externally configured by an operator.

11. The control system according to claim 8, wherein the detection module is further configured to convert each newly assigned current discrete state following a detected state change and each detected request into a transmission vector and to send said transmission vector to the multimodal interpretation module,
each transmission vector presenting a common formatting, the common formatting being common to all transmission vectors sent by the detection module, said common formatting comprising at least fields,
the detection module being configured, for each detected state change, to complete a content of each field of the associated transmission vector as a function of said data characteristics associated with the newly assigned current discrete state following the detected state change,
the detection module being configured, for each detected request, to complete the content of each field of the associated transmission vector as a function of the data characteristics associated with the newly assigned current discrete state following each detected state change from which the request was detected.

12. The control system according to claim 11, wherein the fields comprise a request identification field and at least one essential request field, the content of the request identification field being representative of a fact that the transmission vector is associated with a request, the multimodal interpretation module being configured to determine whether said request is sufficiently complete to be carried out at least if one of the essential fields of the associated transmission vector is empty.

13. The control system according to claim 12, wherein the multimodal interpretation module is configured, in the event of an incomplete request, to complete each empty essential field of the transmission vector associated with the incomplete request, each empty essential field being completed from the content of the corresponding field of the transmission vector associated with the current discrete state of the modal input generated by said other modality.

14. The control system according to claim 1, wherein the detection module is configured to receive at least three distinct modal inputs, the multimodal interpretation module being configured to detect an ambiguity for completing the incomplete request, the ambiguity being between the current discrete states of at least two other modal inputs, said other modal inputs being distinct from each modal input from which the incomplete request was detected,
the system further comprising a disambiguation module configured to provide a disambiguation directive to the multimodal interpretation module in the event of detected ambiguity,
the multimodal interpretation module being configured to complete the incomplete request as a function of said disambiguation directive provided by the disambiguation module.

15. The control system according to claim 14, wherein the disambiguation directive comprises an order of priority over the modal inputs for completing the request,
and/or wherein the disambiguation directive comprises a query request from the user, the multimodal interpretation module then being configured to question the user as a function of the query request by means of a human-machine interface.

16. The control system according to claim 14, wherein the multimodal interpretation module is configured to detect ambiguity between the current discrete states of said at least two other modal inputs, at least when the stored up-to-date data characteristics of said current discrete states, which correspond to a same empty essential field, are contradictory.

17. The control system according to claim 14, wherein the disambiguation directive is stored on a file externally configurable by an operator.

18. The control system according to claim 14, wherein the disambiguation module stores at least two distinct disambiguation directives, each disambiguation directive being associated with a distinct user, the disambiguation module being configured to provide the disambiguation directive as a function of the user originating the incomplete request.

19. The control system according to claim 1, wherein the control system comprises at least two distinct modalities, each modality comprising technical means for acquiring at least one sensory information associated with the user, each modality being configured to generate at least one modal input from the sensory information acquired by the technical means for acquisition, and being configured to send each generated modal input to the detection module; and, preferably, one of the modalities is an acoustic modality, the detection module being configured to detect a user request from at least one discrete state change of the modal input generated by the acoustic modality, and at least one other of the modalities is selected from among a tactile modality, an optical modality or a kinesthetic modality, and preferably at least a further one of the modalities is selected from among a tactile modality, an optical modality or a kinesthetic modality.

20. A control method comprising:
generating at least two distinct modal inputs, each modal input being generated from a same modality or from respectively at least two distinct modalities;
detecting, for each modal input, a discrete state change of the modal input from a previously assigned discrete state toward a newly assigned current discrete state of the modal input, and determination of data characteristics of a current discrete state of the modal input following the detected state change;
detecting a user request from at least one of the modal inputs;
on each detected state change of one of the modal inputs, storing and updating data characteristics of the current discrete state of the modal input following the detected state change; and
at each detected user request, determining whether said request is sufficiently complete to be carried out, and, in an event of an incomplete request, then the incomplete request is completed from at least one of the stored up-to-date data characteristics of the current discrete state of another modal input distinct from each modal input from which the request was detected.
